(19) United States
(12) Patent Application Publication
(10) Pub. No.: US 2016/0223411 A1
(43) Pub. Date: Aug. 4, 2016

(54) THERMOMETER AND MEASURING DEVICE FOR FLUIDS

(71) Applicant: ABB Technology AG, Zuerich (CH)

(72) Inventors: Joerg Gebhardt, Mainz (DE); Ulf Ahrend, Karlsruhe (DE); Kai Koenig, Walldorf (DE); Andreas Decker, Darmstadt (DE); Stephan Wildermuth, Laudenbach (DE); Paul Szasz, Plankstadt (DE); Tilo Merlin, Linsengericht (DE); Horst Schwanzer, Langenselbold (DE)

(21) Appl. No.: 15/012,901

(22) Filed: Feb. 2, 2016

(30) Foreign Application Priority Data
Feb. 4, 2015 (DE) 10 2015 001 405.6

(51) Int. Cl. G01K 11/22; G01K 15/00; G01K 11/00

(52) U.S. Cl. CPC G01K 11/22; G01K 11/006; G01K 15/005

(57) ABSTRACT

A thermometer has at least one temperature sensor, having a physical variable which changes in a characteristic manner depending on temperature, at least one electrical output for emitting a signal which is a measure for the value of the variable, a transmitter for a sound wave or an electromagnetic wave, which transmitter can be coupled to the temperature sensor and controlled thereby depending on the variable's value, or can radiate the wave at least in part towards the temperature sensor, the wave-temperature sensor interaction depending on the variable's value, and either a wave receiver, which reconverts the wave into an electrical signal, or another unit for converting the wave-temperature sensor interaction into an electrical signal, connected to the electrical output.

### CROSS-REFERENCE TO RELATED APPLICATIONS

Priority is claimed to German Patent Application No. DE 10 2015 001 405.6, filed on Feb. 4, 2015, the entire disclosure of which is hereby incorporated by reference herein.

### FIELD

The invention relates to a thermometer and to a measuring device for measuring the temperature of an enclosed fluid.

### BACKGROUND

An electric thermometer contains a temperature sensor having a physical variable which changes in a characteristic manner depending on the temperature to be measured. A signal picked off by the temperature sensor is emitted at the electrical output of said electric thermometer, which signal is a measure for the value of said variable.

In order for the measurement to be as precise as possible, the thermal contact between the temperature sensor and the location and/or medium of which the temperature is to be measured must be as effective as possible. At the same time, said sensor should be influenced as little as possible by the surroundings. However, thermal disturbances are introduced into the temperature sensor via the indispensable electrical supply lines, since the good electrical conductors used are generally also good heat conductors. Many uses also require the location or the medium of which the temperature is to be measured to remain galvanically insulated from the surroundings, i.e. said location may not be electrically connected to the surroundings via the temperature sensor and the supply lines thereof. Under these constraints, it is very difficult to achieve good thermal coupling of the temperature sensor, since good heat-conducting adhesives for example are also good electrical conductors. Finally, the supply lines to the temperature sensor are also subjected to mechanical stress each time the temperature to be measured is changed, since the temperature sensor thermally expands or contracts.

The utility model DE 201 01 270 U1 proposes determining the temperature pyrometrically by means of an infrared measurement in order to alleviate the problems mentioned. However, it is then difficult to thermally decouple the sensor from the surroundings. Increasing requirements for precision make the thermometer disproportionately expensive.

### SUMMARY

An aspect of the invention provides a thermometer, comprising: a temperature sensor including a physical variable which changes in a characteristic manner depending on temperature; an electrical output configured to emit a signal which is a measure for a value of the physical variable; a transmitter for a sound wave or an electromagnetic wave; and a receiver for the wave, connected to the electrical output, wherein the transmitter is either coupled to the temperature sensor and is controlled thereby depending on the value of the physical variable, or wherein the transmitter radiates the wave at least in part towards the temperature sensor, an interaction between the wave and the temperature sensor depending on the value of the physical variable, and/or wherein the transmitter operates as a transmitter/receiver combination communicating with the receiver also operating as a transmitter/receiver combination, characteristics of this communicating depending on the physical variable, and wherein the receiver configured to reconvert the wave into an electrical signal, or a further unit configured to convert the interaction between the wave and the temperature sensor into an electrical signal.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an embodiment of the measuring device according to the invention, comprising a transmitter and receiver in a common housing.

FIG. 2 shows the passive influence of the temperature sensor on the electromagnetic wave.

FIG. 3 shows an embodiment of the measuring device according to the invention, comprising separate units for the transmitter and for the receiver.

### DETAILED DESCRIPTION

A problem addressed by an aspect of the invention is therefore that of providing a thermometer which has a favorable price-precision ratio.

This problem is solved according to an aspect of the invention by a thermometer according to the main claim, and by a measuring device according to the additional independent claim. Further advantageous embodiments can be found in the respective dependent claims referring back thereto.

In an aspect of the invention, a thermometer has been developed. This thermometer comprises at least one temperature sensor having a physical variable which changes in a characteristic manner depending on the temperature. It further comprises at least one electrical output for emitting a signal which is a measure for the value of said variable.

According to an aspect of the invention, the thermometer contains a transmitter and/or receiver comprising a transmitter antenna and/or receiver antenna for a sound wave or an electromagnetic wave. These transmitter and/or receiver components can be coupled to the temperature sensor and can be controlled thereby depending on the value of the variable. Alternatively, said components can emit a signal at least in part towards the temperature sensor, the interaction between the signal and the temperature sensor depending on the value of the variable.

Alternatively or in combination therewith in each case, the transmitter can operate as a transmitter/receiver combination which communicates with a receiver also operating as a transmitter/receiver combination, the characteristics of this communication depending on the variable. For example, a transmitter/receiver (transceiver) arranged on the temperature sensor can communicate bidirectionally with a transmitter/receiver which is spaced apart therefrom and is connected to the electrical output. However, it is also possible for a wave to be radiated from a transceiver of this kind, which is connected to the electrical output, to a transceiver arranged on the temperature sensor. Said transceiver arranged on the temperature sensor can in this case be configured so as to return an echo of the wave radiated in, it being possible for said echo to be modulated in amplitude, frequency or other parameters by the temperature-dependent variable. In a simplified embodiment, it is also possible for the second transceiver not to be coupled to a separate temperature sensor at all, but rather to itself modulate one or more parameters of the returned signal by means of the temperature-dependent change in its receiver and/or transmitter properties.

In order to ultimately achieve an electrical signal at the device output, either a receiver comprising a transmitter and/or receiver antenna for the wave which reconverts said wave into an electrical signal, or another means for converting the interaction between the wave and the temperature sensor into an electrical signal, can be connected to the electrical output.

It has been found that transmitting information via the wave galvanically decouples the temperature sensor from the surroundings and thus makes it possible to significantly better thermally couple the temperature sensor to the location or the medium of which the temperature is to be measured. This connection can in particular also be electrically conductive. Appropriate temperature sensors having sub-Kelvin precision are available at low cost. Galvanic decoupling of the measurement location from the surroundings and good thermal coupling of the temperature sensor to the measurement location are no longer opposing goals.

In an advantageous embodiment of the invention, the transmitter comprising the transmitter and/or receiver antenna is arranged on the temperature sensor and codes the value of the variable into the radiated wave. The temperature sensor can, for example, comprise a thermocouple which delivers a temperature-dependent thermoelectric voltage. However, the temperature sensor can for example also contain a metal or semiconducting temperature-dependent resistor which also produces a temperature-dependent voltage in the event of current flow. The voltage signal can be coded into the wave for example in that the amplitude, phase or frequency of the wave is modulated analogously to the voltage. The value of the voltage as a variable can, however, also be digitized and be transmitted as a digital signal together with the wave. In this case, the transmitter can be supplied with energy in any desired manner. Said transmitter can, for example, contain a battery, be powered by an additional thermoelectric generator, or be supplied with energy via electromagnetic waves radiated thereto.

In an alternative advantageous embodiment of the invention, the temperature sensor is connected in the propagation path of the wave emanating from the transmitter and codes the value of the variable into the transmission, reflection and/or absorption of the wave. For this purpose, the temperature sensor can contain a tuned circuit, the resonant frequency of which is temperature-dependent. A change in the temperature changes the resonant frequency meaning that, at a maintained frequency of the wave, the transmission, reflection and/or absorption changes significantly. The resonant frequency can be changed depending on the temperature for example in that the exact mechanical dimensions of a circuit attached to the temperature sensor change as a result of thermal expansion.

The temperature sensor can for example be arranged relative to the transmitter such that a standing wave field forms between the temperature sensor and the transmitter. The closer to its resonant frequency the tuned circuit on the temperature sensor operates, the greater the amount of energy that is drawn from the standing wave field and has to be delivered subsequently by the energy source of the transmitter in order to maintain the standing wave field.

In a further particularly advantageous embodiment of the invention, the transmitter is configured as an RFID transponder. In this case, it may be an active transponder, which initially draws energy from an electromagnetic field provided when requested, and subsequently independently transmits the value of the variable by means of this energy. However, a passive transponder can also be used, which returns an echo of an electromagnetic wave radiated thereto. The electromagnetic signal radiated in when requested can be converted into a surface acoustic wave for example, which propagates to the temperature sensor. This echo can be designed so as to be temperature-dependent. For example, the positions of reflections produced by the echo can be changed by means of the temperature. However, it is also possible for example for arrangements which at least in part short-circuit, return in phase opposition or in another manner weaken the electromagnetic wave radiated in by the transmitter to be activated or switched off by a microprocessor contained in the RFID transponder. The value of the variable, which is a measure for the temperature, can for example then be coded into this activation and switching off as digital information. Moreover, material variables can change depending on the temperature, so that the characteristic of the echo (delay time, amplitude, phase, attenuation, frequency) changes and can be used for the purpose of measurement.

The weakening or other change in the transmission field can be registered via the power consumption of the transmitter or by means of a receiver for the frequency of the transmission field. However, it can also be registered by means of a receiver which is sensitive to sidebands which arise from the interference of the electromagnetic waves radiated in by the transmitter with the backscattered wave modulated by the temperature sensor. These sidebands can be separated from the original electromagnetic wave by means of simple frequency filtering.

The transmitter can also directly deliver a surface acoustic wave.

Advantageously, the receiver is configured as an RFID read-out unit. A unit of this kind combines the energy supply for the RFID transponder with the evaluation of the data subsequently delivered by the transponder.

In a particularly advantageous embodiment of the invention, the transmitter, the receiver and/or the temperature sensor comprise at least one electrode structure arranged on a piezoelectric substrate for converting an electrical signal into a surface acoustic wave and/or for reconverting a surface acoustic wave into an electrical signal. A passive RFID transponder in particular can be achieved by means of this embodiment.

The physical sensor principle is as follows: surface acoustic waves (SAW) can be stimulated on a piezoelectric substrate. The propagation of said waves can be influenced inter alia by stresses (e.g. pressures), attenuations and the temperature (e.g. via the modulus of elasticity, the shear modulus or the Poisson ratio).

Owing to appropriate arrangement and calibration, possibly also to the use of SAW propagation in different coordinate directions and with different electrode designs, it is possible for these dependencies to be used for the purpose of temperature measurements and further measurements. For example, the propagation time or propagation speed of the waves will be temperature-dependent, meaning that the temperature can be concluded from time delays in the reflected signal.

It is also possible for a plurality of separate electrode structures to be provided, for example a first structure in which the strength of the echo increases as the temperature increases, and a second structure in which the strength of the echo decreases as the temperature increases. The thermometer can thus be particularly sensitized for example to measurements at an upper limit and at a lower limit respectively of a temperature range. Thermometers are frequently used in industrial processes for monitoring so as to ensure that a temperature range of this kind is not left under any circumstances.

Similarly, temperature-dependent changes in the mechanical natural frequencies of the sensor element, changes in the attenuation constants, and in general complex changes in the response characteristic (amplitude, phase, frequency) can be evaluated with respect to the electromagnetic signal radiated in from outside.

Advantageously, the temperature sensor and/or the transmitter comprising the transmitter and/or receiver antenna are arranged on an electrically non-conductive substrate. For the purpose of the best possible thermal coupling, the temperature sensor can then be fixed to the measurement location by means of an adhesive which is optimised for good thermal coupling and which may also be electrically conductive, without the electronic components connected by said adhesive being short-circuited. The substrate can for example be a piezoelectric ceramic material or a board for printed circuits.

In a particularly advantageous embodiment of the invention, the transmitter is arranged in a common housing together with the receiver and/or with the temperature sensor. In this case, said housing shields the transmission path between the transmitter and the receiver and/or between the transmitter and the temperature sensor from external disturbances. Conversely, feedback effects of the thermometer on the surroundings can also be minimized. Advantageously, the housing attenuates the electromagnetic wave radiated from the transmitter by at least 20 dB. If the housing is electrodynamically sealed, any desired frequencies can be used for electromagnetic waves. For this purpose, the housing can consist for example of a metal, such as stainless steel. In order to carry as little heat as possible from the measurement location to the surroundings, said housing can however also consist, at least in portions, of plastics materials or other poor heat conductors which have been made electrically conductive by being covered or coated at least in part with metal for the purpose of electrodynamic sealing.

In a particularly advantageous embodiment of the invention, the housing is able to be evacuated or is filled with a good thermally insulating protective gas. If there is for example a vacuum in the housing, there is particularly good thermal insulation between the transmitter and the receiver and/or between the transmitter and the temperature sensor. The measurement signal transmitted as a wave can, however, overcome this insulation without a problem.

If the housing is filled with a protective gas, said gas can for example be at atmospheric pressure or at a pressure which deviates by at most 200 mbar above or below atmospheric pressure. In this case, no or only slight mechanical strengthening of the housing against the pressure difference is required. A vacuum tends to insulate better, but means that the housing must then withstand the entire atmospheric pressure.

A completely or in part metal housing need not necessarily have dimensions such that far field propagation of the wave is possible therein. In order to also be able to use evanescent near field waves, the transmitter can be arranged at a sufficiently small distance from the receiver and/or the temperature sensor.

In a further advantageous embodiment of the invention, the transmitter and the receiver are arranged in separate units which are mechanically decoupled from one another. A set-up of this kind permits relative movements between the transmitter and the receiver, such as can occur on account of thermal expansions. A common housing which is rigidly clamped both at the measurement location and at another location in the surroundings can be subjected to high mechanical stress when there is a temperature change at the measurement location.

In a further particularly advantageous embodiment of the invention, a plurality of temperature sensors are provided for recording a spatial temperature profile. These sensors can cooperate in particular with a single receiver, for example a central RFID read-out unit. The construction of the equipment for recording the spatial temperature profile is thereby reduced. A plurality of temperature sensors which deliver their measurement data to a central point can, of course, also be provided for a motive other than that of recording a spatial temperature profile.

Advantageously, an evaluation unit is provided, which consults the temperature profile for the purpose of calibrating or correcting at least one measured temperature. Delay times, for example, which occur in the case of heat penetrating through a wall, can be concluded from the temperature profile. In general, the plurality of sensor elements attached can be used in order to increase the measurement precision, for example by means of appropriately weighted averaging.

A preferred use for the thermometer according to the invention is a measuring device for measuring the temperature of a fluid enclosed in a container or in a pipe, this measurement being carried out on the outside of the wall of the container or the pipe. Specifically in this use, good thermal coupling of the temperature sensor to the outside of the wall is particularly important. At the same time, specifically in this use, it is often required for the wall not to be galvanically connected to the surroundings when the temperature is measured.

A recess for receiving the thermometer at least in part is advantageously arranged in the outside of the wall of the container or the pipe. Said recess reduces influences from the surroundings on the surface on the outside of the wall of which the temperature is measured using the thermometer. It is also particularly advantageous to introduce the temperature sensor into a thermometer protection tube (thermowell) which is guided through the wall of the container or the pipe.

The ISM frequencies provided for industry, research and medicine can preferably be used as frequencies for the electromagnetic waves. However, the invention is not restricted to these frequencies.

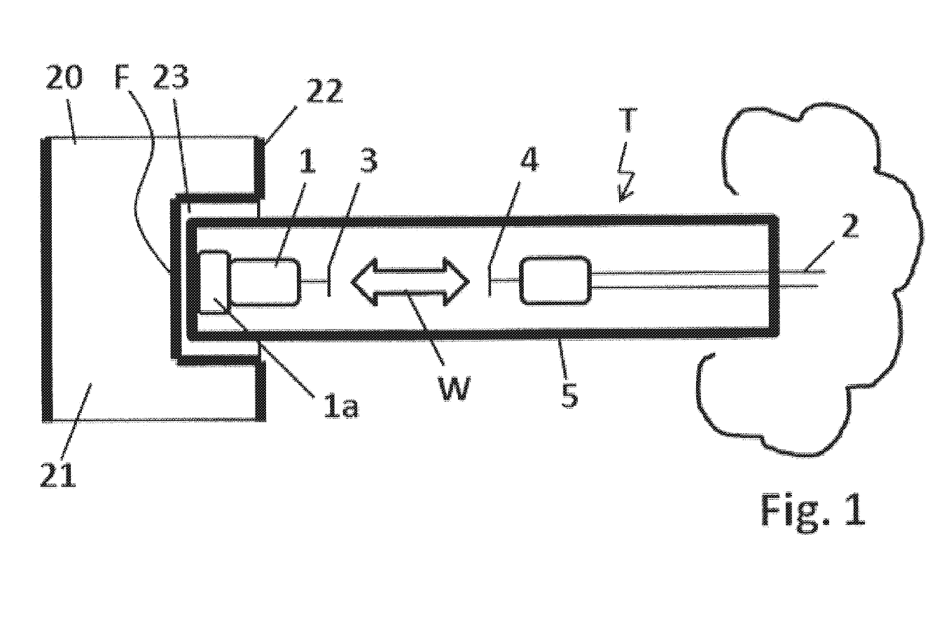

FIG. 1 shows an embodiment of the measuring system according to the invention. The temperature of a medium 21, which is guided in a pipe 20, is to be measured on the surface F of the outside of the wall 22. Said surface F is surrounded by a recess 23, which can also be formed as a thermometer protection tube guided through the wall 22, for receiving the thermometer T at least in part.

The thermometer T comprises a housing 5. The temperature sensor 1 is fastened to the left-hand end face of said housing 5 by means of a heat-conducting adhesive 1a. The temperature sensor 1 is connected to a transmitter 3 which is able to radiate microwaves towards the receiver 4. The receiver 4 is configured as an RFID read-out unit and first supplies the transmitter 3 with energy by means of radiating in electromagnetic waves before the transmitter 3 in turn transmits. The signal registered by the receiver 4 is a measure for the temperature on the surface F and is emitted at the electrical output 2 of the thermometer T. The housing 5 is produced from stainless steel.

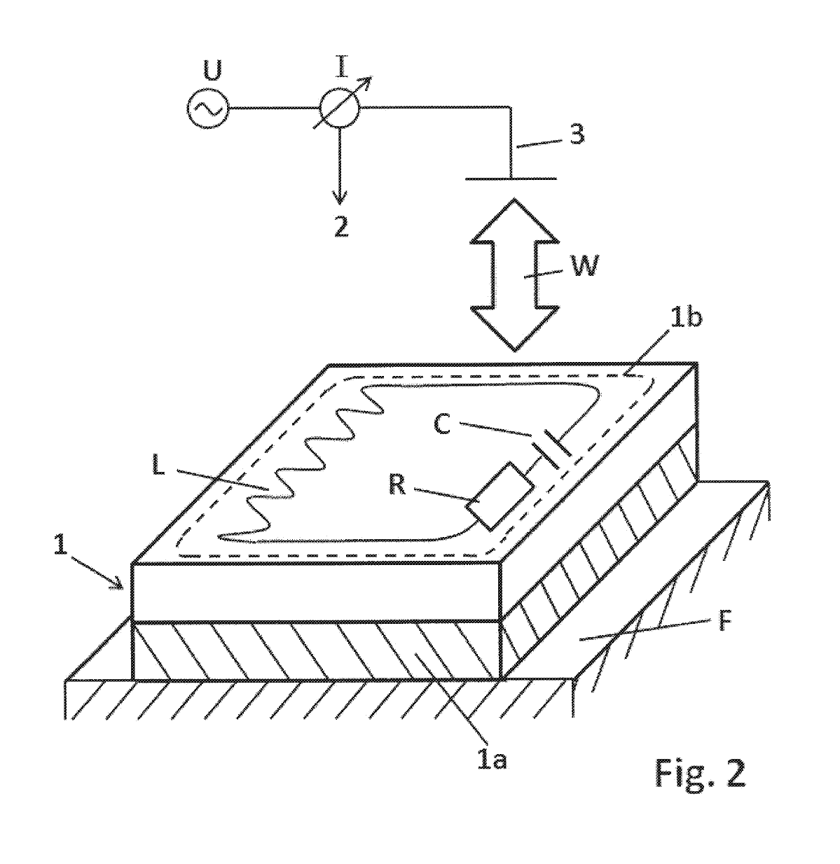

FIG. 2 illustrates the passive influence of the temperature sensor 1 on an electromagnetic wave W, which influence is simpler to produce than the active RFID transponder used according to FIG. 1. The temperature sensor 1 is mounted by means of a heat-conducting adhesive 1a on the surface F of which the temperature is to be measured. A tuned circuit 1b, consisting of an inductor L, a capacitor C and a resistor R, is constructed on the surface of the temperature sensor 1 facing away from the adhesive 1a. The inductor L is formed as narrow zig-zags, which are arranged on the substrate 1 as conductor tracks. When the temperature sensor 1 is heated, the spacings between the zig-zags change, and thus the inductor L value changes. As a result, the resonant frequency of the tuned circuit 1b shifts.

The electromagnetic wave W is radiated in by the transmitter 3. The transmitter 3 is powered by an alternating current source U. A current measuring device I, the measurement value of which is emitted at the output 2 of the thermometer, is connected between the alternating current source U and the transmitter 3.

During operation, a standing wave field propagates between the transmitter 3 and the temperature sensor 1. The closer the resonant frequency of the tuned circuit 1b is to the frequency of the wave W, the greater the amount of energy that is dissipated in the tuned circuit 1b and has to be delivered subsequently by the alternating current source U. The temperature at the surface F can be concluded from the corresponding signal at the current measuring device I.

The tuned circuit 1b on the temperature sensor 1 can also be replaced by a device for converting the electromagnetic wave W into surface acoustic waves in conjunction with a course for said surface acoustic waves extending along the surface of the temperature sensor 1. For this purpose, a piezoelectric substrate is selected for the temperature sensor 1.

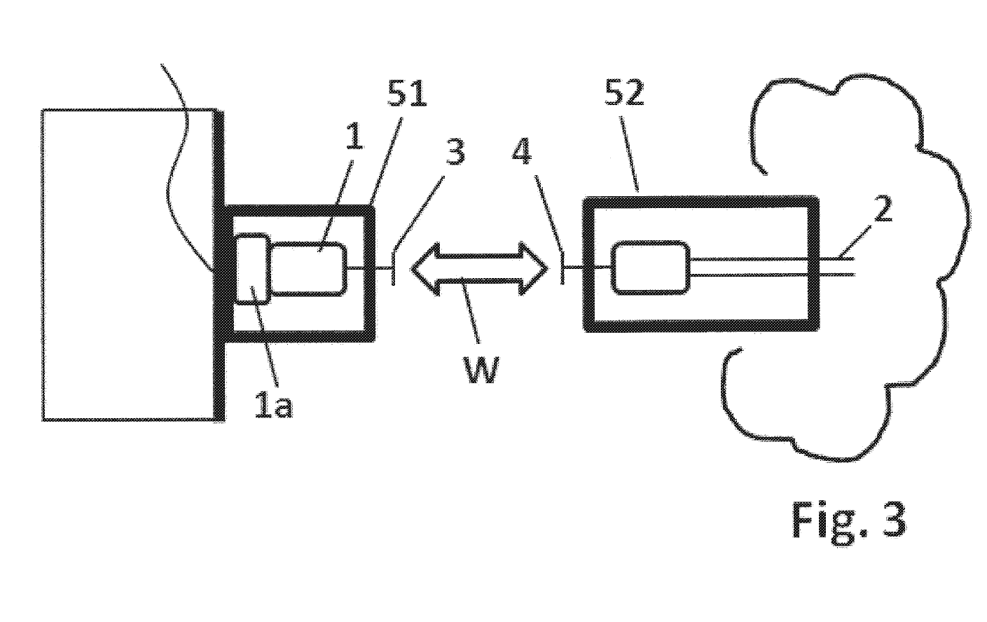

FIG. 3 shows a further embodiment of the measuring system according to the invention. The temperature sensor 1 is rigidly bonded to the inside of a first unit 51 by means of heat-conducting adhesive 1a. Said temperature sensor contains a transmitter 3, the antenna of which protrudes from said unit. A second unit 52 contains the receiver 4, the antenna of which likewise protrudes from said unit 52. The receiver 4 converts the electromagnetic wave W transmitted by the transmitter back into an electrical signal, which is emitted at the electrical output 2 of the thermometer. At the same time, by radiating in an electromagnetic wave, the receiver 4 supplies the transmitter 3 with the energy the transmitter 3 subsequently needs in order to transmit. The set-up shown in FIG. 3 permits any desired relative movements between the units 51 and 52, without said units being subjected to mechanical stress. The housing 51 can therefore be connected in a mechanically rigid manner to the surface F of which the temperature is to be measured, while the unit 52 can also be rigidly mounted at another fixed or movable point in the surroundings.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SIGNS

.1 temperature sensor

1a adhesive

1b tuned circuit

2 electrical output

3 transmitter or first transmitter-receiver combination

4 receiver or second transmitter-receiver combination

5 housing

51, 52 units

20 pipe

21 fluid in the pipe 20

22 wall of the pipe 20

23 recess or thermometer protection tube in the wall 22

C capacitor of the tuned circuit 1b

F surface of which the temperature is to be measured

I current measuring device

L inductor of the tuned circuit 1b

R resistor of the tuned circuit 1b

T thermometer

U alternating current source

W sound wave or electromagnetic wave

1. A thermometer, comprising:
a temperature sensor including a physical variable which changes in a characteristic manner depending on temperature;
an electrical output configured to emit a signal which is a measure for a value of the physical variable;
a transmitter for a sound wave or an electromagnetic wave; and
a receiver for the wave, connected to the electrical output,
wherein the transmitter is either coupled to the temperature sensor and is controlled thereby depending on the value of the physical variable, or
wherein the transmitter radiates the wave at least in part towards the temperature sensor, an interaction between the wave and the temperature sensor depending on the value of the physical variable, and/or
wherein the transmitter operates as a transmitter/receiver combination communicating with the receiver also operating as a transmitter/receiver combination, characteristics of this communicating depending on the physical variable, and
wherein the receiver configured to reconvert the wave into an electrical signal, or a further unit configured to convert the interaction between the wave and the temperature sensor into an electrical signal.

2. The thermometer of claim 1, wherein the transmitter is arranged on the temperature sensor, and
wherein the transmitter codes the value of the physical variable into the wave, which the transmitter radiates.

3. The thermometer of claim 1, wherein the temperature sensor is connected in a propagation path of the wave emanating from the transmitter, and
wherein the temperature sensor codes the value of the physical variable into the transmission, reflection, and/or absorption of the wave.

4. The thermometer of claim 1, wherein the transmitter is configured as an RFID transponder.

5. The thermometer of claim 1, wherein the transmitter is configured as a generator for surface acoustic waves.

6. The thermometer of claim 1, wherein the receiver is configured as an RFID read-out unit.

7. The thermometer of claim 1, wherein the transmitter, the receiver, and/or the temperature sensor include an electrode structure arranged on a piezoelectric substrate
wherein the electrode structure is configured to convert an electrical signal into a surface acoustic wave and/or to reconvert a surface acoustic wave into an electrical signal.

8. The thermometer of claim 1, wherein the transmitter is arranged in a common housing together with the receiver and/or with the temperature sensor.

9. The thermometer of claim 8, wherein the housing is configured to attenuate the electromagnetic wave radiated from the transmitter by at least 20 dB.

10. The thermometer of claim 8, wherein the housing is able to be evacuated or is filled with a protective gas having low thermal conductivity.

11. The thermometer of claim 1, wherein the transmitter and the receiver are arranged in separate units which are mechanically decoupled from one another.

12. The thermometer of claim 1, wherein the temperature sensor can be supplied with energy via electromagnetic waves radiated thereto.

13. The thermometer of claim 1, comprising:
two or more temperature sensors, configured to record a spatial temperature profile or for increasing measurement precision using appropriately weighted averaging.

14. The thermometer of claim 13, further comprising:
an evaluation unit,
wherein the evaluation unit consults a temperature profile for calibrating or correcting at least one measured temperature.

15. A measuring device for measuring a temperature of a fluid enclosed in a container or in a pipe, the device comprising:
the thermometer of claim 1, configured to measure a temperature outside of a wall of the container or the pipe.

16. The device of claim 15, comprising:
a recess for receiving the thermometer at least in part arranged in the outside of the wall of the container or the pipe.

17. The device of claim 15, wherein the temperature sensor and/or the transmitter and/or a receiver unit, comprising the transmitter and receiver, is arranged in a thermometer protection tube which is guided through the wall of the container or the pipe.

18. The thermometer of claim 1, comprising two or more temperature sensors.

19. The thermometer of claim 1, comprising two or more electrical outputs.
